(19) United States
(12) Patent Application Publication
(10) Pub. No.: US 2008/0281718 A1
(43) Pub. Date: Nov. 13, 2008

(54) HOUSEHOLD NETWORK INCORPORATING SECURE SET-TOP DEVICES

(76) Inventor: Barrett Morgan, Salt Lake City, UT (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/971,040

(22) Filed: Jan. 8, 2008

Related U.S. Application Data
(60) Provisional application No. 60/879,315, filed on Jan. 8, 2007.

(51) Int. Cl. G06Q 30/00; G06Q 20/00; H04N 7/173

(52) U.S. Cl. 705/26; 725/109

(57) ABSTRACT

A method for establishing a household network that includes providing a secure set-top device (SSD) operably connected to the Internet; assigning the SSD to a credit card account to define a household network associated with the SSD; enrolling a digital media device in the household network; and requesting a digital media file for a digital media device within the household network. A digital media file may be requested via any device in the household network by a process that may include verifying that the digital media file is valid for the household network and if valid, causing the SSD to process the request, including identifying the digital media device and authorizing a charge to the credit card account, if required, to complete the request.

### RELATED APPLICATION

The present application claims priority to U.S. Provisional Application No. 60/879,315, filed Jan. 8, 2007, and entitled “HOUSEHOLD NETWORK INCORPORATING SECURE SET-TOP DEVICES,” which is incorporated by reference herein in its entirety.

### FIELD OF THE INVENTION

The present invention relates generally to methods and systems for delivery of digital media content, such as movies, photos, television, music, games and other digital media, over a household network. More particularly, the present invention relates to methods and systems for delivery of legally-obtained copyrighted digital content, or consumer-generated digital content, to a secure set-top device (SSD) linked to other digital media devices incorporated into a household network (HHN).

### BACKGROUND OF THE INVENTION

For almost two hundred years from the original Copyright Act of 1790 in the United States, protection of the creative works of authors and artists relied on a balance of legal, technical and social restraints to keep piracy of copyrighted materials in check. The technical challenges of mass reproduction of written or recorded works in an era before photocopiers and tape recorders and computers along with clear social prohibitions against theft of the property meant that copyright laws were primarily directed to criminal and civil penalties for large scale commercial piracy.

With the advent of digital media content, the traditional balance of restraints against copyright piracy has been thrown into turmoil. In response to the rapid technological progress for making copies of digital media, modern laws such as the Audio Home Recording Act of 1992 (AHRA), the Digital Millenium Copyright Act of 1998 (DMCA), and the Family Entertainment and Copyright Act of 2005 in the United States take particular aim at these digital technologies in an attempt to thwart the growth of digital piracy of copyrighted music, movies, software and other creative works.

These modern, increasingly restrictive digital-specific copyright laws impose significant financial and criminal penalties for violations of copyright infringement. For commercial pirates copying and distributing unauthorized works en masse, the new laws raise the risk of the illegal venture, and present new technological challenges. For the average consumer with an ever-increasing array of digital media devices in his or her home, many capable of easily creating and sharing digital copies, digital-specific copyright laws create tension and confusion in terms of what kinds of copying, sharing and backing up of digital information is permitted.

As digital technology took root, the entertainment and software industries initially relied on the inconvenience of single-use mediums and restrictive single-use user licenses as technical and legal hurdles against consumers creating copies of digital files. With the continued development of digital technology, consumers now have the convenience of easily copying and exchanging works in multiple formats and accessing those works over multiple channels, including downloading works from the Internet. The response by the entertainment and software industries has been to promote the protection copyrighted digital content through an expansive, elaborate web of protective technology often referred to broadly as “Digital Rights Management” or simply, “DRM”.

For the average consumer, new DRM and digital-specific copyright laws have become so complicated as to effectively thwart the ability of consumers to make legal copies of digital media content under the long recognized personal-use and archiving exceptions to copyright infringement. Even if a consumer manages to overcome the DRM technology built into one particular digital media device or media file, additional DRM roadblocks in other media devices can prevent the legal sharing of digital files for personal, non-commercial use. For example, pre-recorded digital video discs (DVDs) purchased in a retail setting can include a digital lock known as a “content scrambling system” (CSS) that prevents copying of the DVD. Industry-standard DVD players all recognize CSS, and the disc may be played on virtually any DVD player. However, movie studios have yet to allow movies downloaded from the Internet from services such as Movielink, CinemaNow, and Amazon.com's Unbox to employ CSS for fear of widespread burning of DVDs. Under these instances, a movie may be downloaded to a personal computer (PC), but may not be played back on a DVD player in the living room or the automobile for lack of a transferable copy.

One response to this consumer dilemma has been to develop alternative DRM. Using the CSS example, Sonic Solutions Inc. has introduced a CSS alternative, Qflix, whereby the new technology adds a “lock” to DVDs yet allows the burning of a single DVD. Movie studios appear ready to embrace such technology, but unfortunately the consumer will need to purchase a new proprietary DVD burner to make this single permissible copy, adding yet another device and another technology to home digital technology collection of the consumer.

Another response to this consumer dilemma has been to attempt to provide ways to link the variety of digital media devices found in a home into a single local area network. These solutions generally have focused on utilizing the personal computer (PC) as the hub for downloading, storing and managing digital media files. For example, numerous media adapters offered by providers such as Netgear, D-Link, and Buffalo Technology sell devices resembling set-top boxes that promise to link a consumer's PC to a television. The technology enables a consumer to view media content stored on a PC, such as downloaded movies, home videos, and photos, on their TV sets. The successful iPod device by Apple Computer relies on use of the iTunes software running on one or more PCs to control download and management of digital media files, such as songs, television shows and movies.

Such a PC-based system for managing content on a home network is described in U.S. Patent Application Publication US 2007/0192797 “Method of and Apparatus for Managing Distributed Contents.” The disclosed system relies on a central PC to aggregate and synchronizes media content across multiple device in a home network. One drawback to this type of system is that the aggregation and synchronization processes fail to incorporate any copyright control or copyright framework.

Another drawback to this approach is that the “network” fails to truly link the multiple devices in a single household, and instead relies on funneling digital media files through a PC. From the perspective of the entertainment and software industries, using the PC as a hub for a home network creates more opportunities for sophisticated users to download programs that hack into and circumvent the DRM protection scheme. From the consumer perspective, the use of the PC as a hub limits the potential ability to make legal copies to those users who are savvy enough to utilize the PC and successfully link up the PC to all of the various digital media devices in the consumer's home.

The system described in U.S. Patent Application Publication No. US 2006/0156392 “System and Method for Localizing Data and Devices,” takes another approach to managing household networks. The system relies on IP networking addressing to credential and enroll household network hubs and devices. A device becomes associated with a specific network location, and this association in conjunction with various DRM specifications, determines access to protected digital content. Unfortunately, such a system may break down with a change of ISP or network service provider, requiring an inconvenient re-enrollment of devices. Furthermore, with limited user intervention in the credentialing and enrollment of devices into the household network, the user remains removed from the process of managing and controlling a household network.

Given the numerous approaches to copyright protection, the challenges for the average consumer in attempting to transfer digital media files across all of the variety of different kinds and types of digital media players can seem like trying to simultaneously understand all of the languages spoken at a session of the United Nations. While these kinds of technical challenges may be beneficial as a deterrent against piracy of the digital content of commercial copyright owners, these technical incompatibility challenges also frustrate the legitimate rights of consumers to create, share and copy consumer generated digital media content such as photos and home movies.

Unfortunately, none of the current approaches for protection of copyrights in digital media content adequately balances the needs of commercial digital content providers for copyright protection against the legitimate rights of consumers to make personal-use copies of commercial digital media files and also freely disseminate consumer-generated digital content within a network of household devices. Therefore, it would be desirable to provide methods and systems for managing the reproduction and exchange of digital media files across multiple digital media devices located in a household network, while protecting the rights of commercial digital content providers.

### SUMMARY OF THE INVENTION

The present invention is a method and system for managing digital media files (DMF) in a household network (HHN) that includes at least one secure set-top devices (SSDs) linked to multiple digital media devices. SSDs can include digital entertainment centers (DECs), personal video recorders (PVRs), secured portable devices (SPDs) and secured auto devices (SADs) that are purchased by consumers or supplied by digital media content providers. Each SSD includes a mass storage device containing consumer-generated digital media files and authorized commercial digital media files. Unlike traditional personal computers that can access digital content using browser interfaces running on computer displays, the SSDs have limited operating system access with no browser interfaces and are designed to be operated by the consumer from a common navigation and program guide user interface displayed on the screen of a digital media device. The limited operating system encourages voluntary compliance with copyright laws by reducing the ability of the average consumer to directly access the software that manages the sharing of DMF on the HHN.

The SSD may include at least one connection to a content source such as cable or satellite television or the Internet, while connecting to multiple digital media devices that comprise the household network. For purposes of the present invention, a “household” comprises a single consumer, or multiple consumers sharing a familial or other interpersonal relationship, controlling and operating the SSD and multiple media devices in a not-for-profit manner. “Household” does not encompass multiple-family dwelling spaces such as entire apartment complexes, dormitories, condominium and townhouse associations, and other multi-unit buildings or organizations. Nor does the term household include for-profit organizations such as businesses, or even non-profit organizations such as churches or schools. Digital media devices may include such as digital video cameras, digital cameras, automobile digital video players or recorders, portable media devices (PMDs), monitors or television sets, and even personal computers. Furthermore, each digital media device may have an electronically identifiable serial number to identify the digital media device to an SSD. Acting as the central hub of the HHN, the SSD authorizes digital media devices to join or leave the HHN, and distributes DMF automatically to connected digital media devices. In one embodiment, the distribution of DMF among digital media devices in the HHN is based on a predetermined priority ranking.

In one embodiment, the SSD is connected to a global server and other remotely located digital media devices via the Internet. The global server includes a database containing information regarding the HHN. This information may include SSD serial number, consumer credit card number, location, authorized number of digital media devices, EULA particulars, and other information specific to the HHN. The global server or the SSD may also include a copyright framework that determines the number of authorized copies of commercial DMF that may be stored on or played by devices in the HHN. In one embodiment, the HHN becomes a credentialed HHN by authorizing a content provider to make a charge to a consumer's credit card based on violations of the copyright framework embedded in and employed by the HHN. In one embodiment, the Internet-connected HHN is part of a larger virtual private network (VPN) and exchanges DMF with other SSDs in the VPN using peer-to-peer (P2P) file-sharing techniques. The P2P file-sharing techniques may include a swarm casting technique.

The above summary of the various embodiments of the invention is not intended to describe each illustrated embodiment or every implementation of the invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a diagram illustrating an overall schematic of an HHN in accordance with one embodiment of the present invention;

FIG. 2 is a diagram illustrating an overall schematic of an HHN utilizing a router in accordance with one embodiment of the present invention;

FIG. 3 is a graphical representation of an exemplary navigation and program guide user interface used to control devices in an HHN in accordance with one embodiment of the present invention;

FIG. 4 is a diagram illustrating an overall schematic of an HHN linked to the Internet in accordance with one embodiment of the present invention;

FIG. 4a is a graphical representation of an exemplary navigation and program guide user interface requesting user verification of a credit card assignment;

FIG. 5 is a diagram illustrating an overall schematic of an HHN linked to a virtual private network (VPN) in accordance with one embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

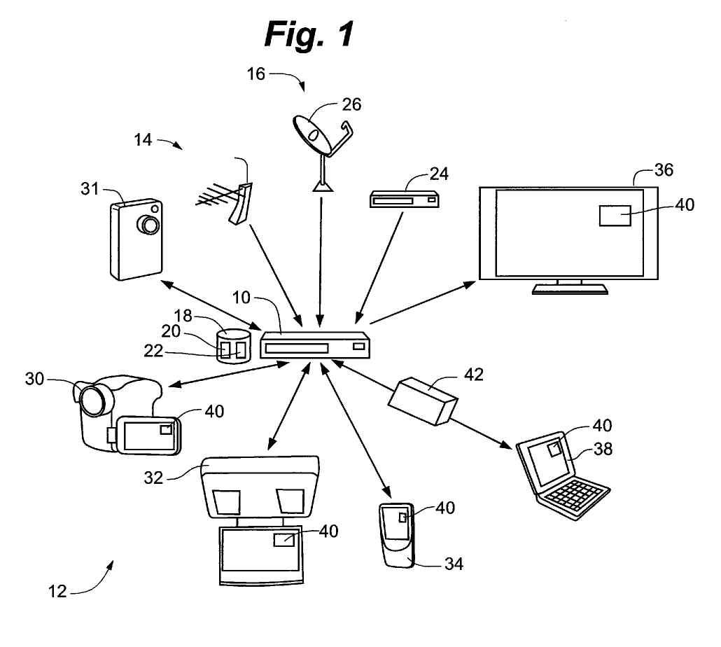

FIG. 1 depicts an SSD 10 linked to a multitude of heterogeneous digital media devices 12 and content sources 16 to form an HHN 14 in accordance with one embodiment of the present invention.

For purposes of the present invention, a “household” comprises a single consumer, or multiple consumers sharing a familial or other interpersonal relationship, controlling and operating the SSD and multiple digital media devices in a not-for-profit manner. Though in some embodiments, a digital media device 12 may connect remotely to HHN 14, the household generally is located within a single-family dwelling, such as a house or an apartment unit. Perhaps the most obvious example of a “household” is a traditional nuclear family living in the same housing unit. Another example is a pair of college roommates living together in an apartment unit. “Household” does not encompass multiple-family dwelling spaces such as entire apartment complexes, dormitories, condominium and townhouse associations, and other multi-unit buildings or organizations. Nor does the term household include for-profit organizations such as businesses, or even non-profit organizations such as churches or schools.

Furthermore, to stay within the definition of a “household” network, the number of digital media devices 12 incorporated into HHN 14 is limited. In one embodiment, ten digital media devices may be included in HHN 14. HHN 14 includes less than twenty-five digital media devices 12, but in no case will the number of digital media devices 12 in one HHN 14 exceed one hundred.

Still referring to FIG. 1, SSD 10 of HHN 14 includes a mass storage 18 that selectively stores commercial digital media content files (DMF) 20 and consumer-generated DMF 22, such as a hard disk drive (HDD). For purposes of the present invention, the term SSD will be used to apply to various configurations of digital content storage devices equipped in accordance with one or more of the various embodiments of the present invention, including digital entertainment centers (DECs), personal video recorders (PVRs), secured portable devices (SPDs) and secured auto devices (SADs). In this embodiment, each SSD 10 has an electronically identifiable serial number or other feature or set of features to identify SSD 10.

In one embodiment, an SSD 10 is purchased by a retail consumer at a retail outlet or over the Internet. In another embodiment, an SSD 10 is supplied by a digital media content provider, such as a cable television service provider, in exchange for a consumer paying a periodic fee for access to DMF and/or use of the SSD.

It will be understood that other types of mass storage devices, such as flash memory, bubble memory, optical read/write memory and the like may also be utilized for the mass storage 18. In one embodiment, the HDD of each SDD is, for example, a 200 GB hard drive. It will be understood that the relative size of the mass storage 18 of each SSD 10 will be primarily a function of economics and currently available mass storage technologies. SSDs 10 of the present invention are further described in U.S. patent application Ser. No. 11/649,331, “Digital Content Delivery Via Virtual Private Network (VPN) Incorporating Secured Set-Top Devices,” filed Jan. 3, 2007; and U.S. patent application Ser. No. 11/649,351, “Ubiquitous Navbar User Interface Across Multiple Heterogeneous Digital Media Devices,” filed Jan. 3, 2007, the disclosures of which are hereby incorporated by reference.

SSD 10 in one embodiment includes at least one input connection to content sources 16 such as cable television 24, satellite television 26 and over-the-air television 28, as well as media players such as CD players, DVD players or the like. Each SSD also includes connections, either wireless, wired or via a network arrangement, to one or more of a variety of display-based digital media devices 12 such as digital video cameras 30, digital cameras 31, automobile digital video players or recorders 32, portable media devices (PMD) 34, monitor/television sets 36, and in some embodiments personal computers 38. If a PC 38 is connected to HHN 14, connection is may be through a security-enabled arrangement 42 limiting the ability of PC 38 to copy DMF from SSD 10. Additional digital media devices not depicted but possibly included in HHN 14 include but are not limited to digital photo display frames, audio-based digital media devices such as PMPs, stereo systems and other portable and automobile-based audio and video players.

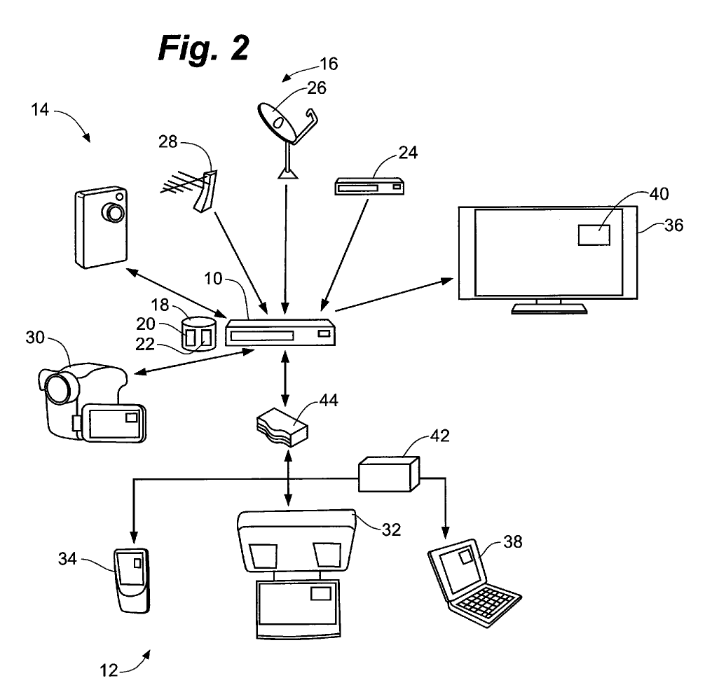

Digital media devices 12 may be connected directly to SSD 10 via cable connection to ports on the SSD 10, including USB ports, HDMI ports and the like. Digital devices 12 may also be connected to SSD 10 through the use of a local wired or wireless router 44 as depicted in FIG. 2. A variety of different wireless local area networks, such as WiFi, WiMax, or similar networks, or wired networks such as Ethernet or PowerLine or similar networks, or any combination of such networks may be arranged into configurations of HHN 14.

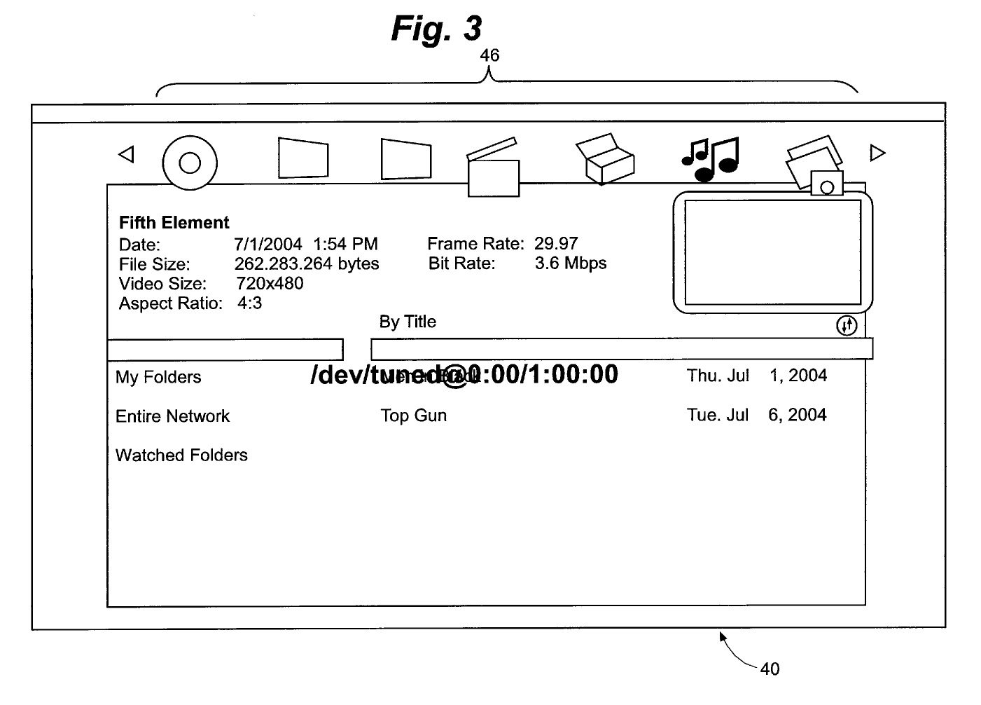

Referring to FIG. 3, each digital media device 12 includes a common navigation and program guide (NPG) user interface 40 as described in detail in U.S. patent application Ser. No. 11/649,351, “Ubiquitous Navbar User Interface Across Multiple Heterogeneous Digital Media Devices,” filed Jan. 3, 2007, the disclosure of which is hereby incorporated by reference. NPG user interface 10 may be accessed through any of the digital media devices 12. In one embodiment, NPG user interface 40 presents a limited set of selectable icons 46 associated with different kinds of digital media content and operations of digital media devices 12. NPG user interface 40 also selectively displays information about the DMF and device operation in a grid format that is consistent across the multitude of digital media devices 12. NPG user interface 40 operates as a browser-less system, avoiding formatting and other display issues associated with displaying a common user interface across multiple screen sizes with varying capabilities.

Importantly, in this embodiment the limited operating system of NPG user interface 40 reduces the ability of hackers to penetrate the security of the networked devices and access stored content for the purposes of illegal copying. Unlike hacker-friendly, browser-based devices and systems, the limited functionality of the operating system of the NPG user interface 40 encourages voluntary compliance with copyright law by making it difficult to access DMF 20 through anything but limited user interface 40.

In one embodiment, SSD 10 and its connected digital media devices 12 comprise a single family, or brand, of products purchased by a consumer. In another embodiment, SSD 10 and digital media devices 12 may be produced by more than one manufacturer and include a variety of brands and platforms. In one embodiment, each digital media device 12 has an electronically identifiable serial number or other feature or set of features to identify the digital media device to an SSD 10 or another device external to HHN 14.

Commercial DMF 20 includes movies, television shows, music, games, programs and other authorized, commercially distributed, and presumably copyrighted DMF. SSD 10 may receive commercial DMF from content sources 16, which are then stored on mass storage 18 and distributed to the appropriate digital media devices 12. Commercial DMF 20 may also be downloaded by SSD 10 from digital media devices 12 connected to HHN 14 or even via internet connection to other digital content sources as discussed further below. Commercial DMF 20 may also include a digital fingerprint used to identify it as a commercial, copyrighted work.

Consumer-generated DMF 22 may include home videos, personally composed music files, digital photographs, consumer-written software programs, or data files for which the consumer will be the copyright owner or for which the consumer has another authorized, non-commercial relationship with the consumer, such as family and friends.

As depicted in FIGS. 1-3, SSD 10 acts as a local hub for HHN 14, managing the digital media devices 12. For example, when a digital media device 12 is introduced to HHN 14, SSD 10 automatically identifies the device by serial number, and determines whether it may be enrolled in HHN 14, or not. In other embodiments, SSD 10 may enroll a digital media device 12 into HHN 14 based upon an authorized IP address. For example, if a digital media device 12 resides at a known local IP address, SSD 10 may enroll device 12 based on the local address. A similar technique is described in U.S. Patent Application Publication No. US 2006/0156392 “System and Method for Localizing Data and Devices,” which is hereby incorporated by reference.

In some embodiments, a digital media device 12 that belongs to another HHN 14 may not be authorized to join the HHN in order to control the exchange of unauthorized commercial DMF 20 and prevent an HHN 14 from storing or playing more than an authorized number of copies of DMF 20. In one embodiment, a digital media device 12 may belong only to a single HHN 14, and may not join a second HHN 14 without being dropped from a first HHN 14. HHN 14 and SSD 10 may determine when and if a digital media device 12 may leave one HHN 14 to join another HHN 14.

In addition to acting as a storage device for commercial and consumer DMF 20 and 22, SSD 10 acts as a manager of DMF, automatically operating HHN 14 within the bounds of copyright law by limiting storage, access, and distribution of commercial DMF 20. This management feature is particularly useful when HHN 14 is connected to the Internet, where the potential for the exchange of unauthorized copies of commercial DMF 20 may be greater than if the HHN 14 is not connected to the Internet.

In one embodiment, SSD 10 acts as a hub, receiving consumer DMF 22 from one digital media device 12 and distributing it to another digital media device 12. For example, a digital camera 31 and a digital photo display frame are both connected to SSD 10 as part of HNN 14. SSD 10 receives consumer DMF 22, digital photos, from digital camera 31. SSD 10 then sends the digital photos over HHN 14 to the digital photo display frame where the photos become available for viewing by a consumer. In another example, SSD 10 receives digital photos from digital camera 31, which are then made immediately available at monitor/television set 36 for viewing by a consumer.

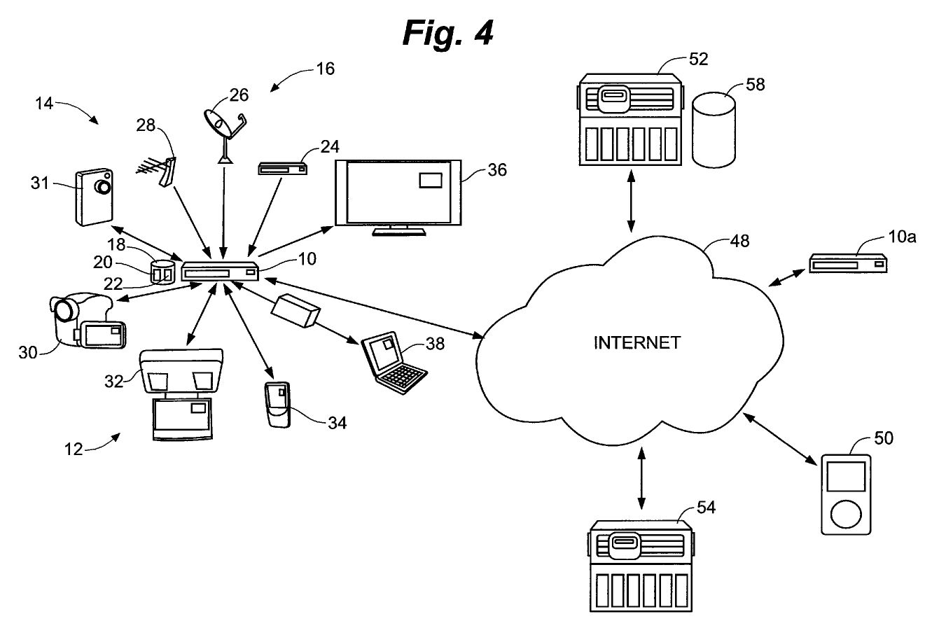

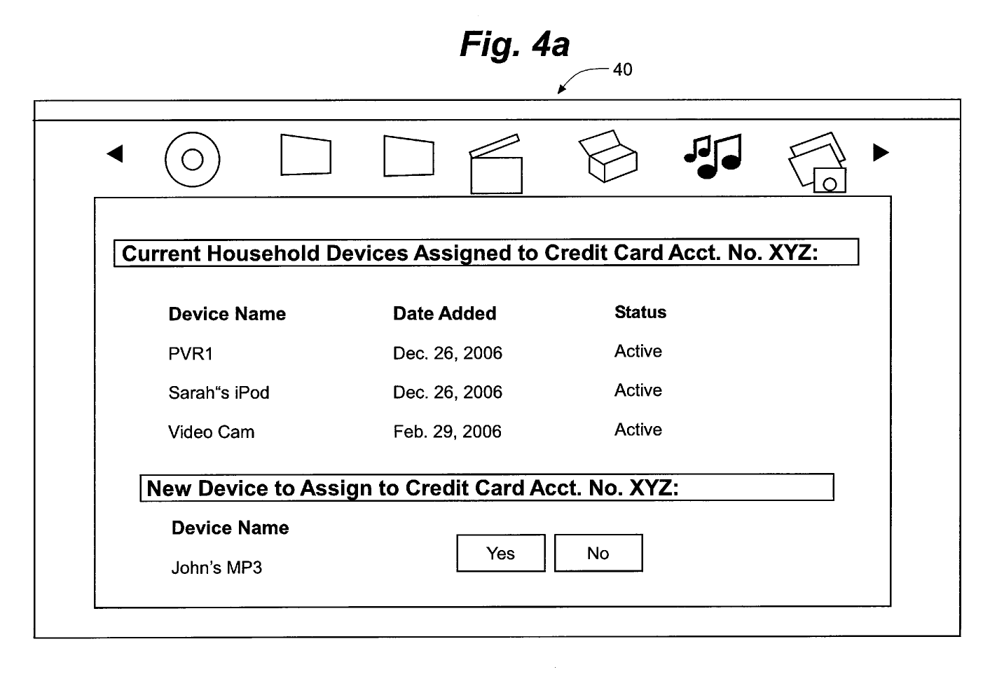

Referring now to FIG. 4, HHN 14 is connected via Internet 48 to global server 52, content server 54, SSD 10a, and PMP 50. Global server 52 includes database 58 which contains data regarding individual SSDs 10, and in some embodiments, information regarding digital media devices 12 of HHN 14. Basic SSD 10 information stored on global server 52 may include SSD serial number, consumer credit card number, SSD location, authorized number of digital media devices, EULA particulars, and other information specific to HHN 14. In one embodiment, global server 52 may also include copyright information that determines the number of authorized copies of a particular commercial DMF 20 that may be distributed to digital media devices 12 over HHN 14, as well as how many copies may be played by digital media devices 12 at one time. This copyright information may be tailored to meet the particular requirements of the jurisdiction in which SSD 10 and HHN 14 are located or may be tailored for the specific requirements of a given EULA.

For example, global server 52 supporting an SSD 10 and HHN 14 located in the United States may authorize SSD 10 to distribute a specific number of total copies of any commercial digital movie file to digital media devices 12 on the HHN 14, but authorize SSD 10 to only allow one copy at a time to be played by a given digital media device 12. In this example, there may be an authorized ability to also make a specific number of physical backup copies on digital media, such as backup DVD or CD. In another example, SSD 10 may be authorized to distribute an unlimited number of copies of digital music files to all digital media devices 12 in HHN 14 that are capable of playing such audio files but restricts the ability to make separate physical backup copies on digital media. In an alternate embodiment, the above-mentioned SSD 10 data, including copyright management information, is located on the HDD of SSD, rather than on global server 52.

Global server 52 may also perform a registration process, recording serial number and other data regarding a digital media device 12 in an HHN 14, sent from an SSD 10. The global server 52 may also authorize an SSD 10 to add a digital media device 12 to an HHN 14, as well as assist in the linking of a digital media device 12 to an SSD 10 and HHN 14 through Internet 48. Additional implementations of embodiments along with further details on the role of global server 52 may be found in Attachment A, of the previously identified provisional application which has been incorporated by reference.

In one embodiment of the present invention, when a digital media device 12 is authorized to join HHN 14, or when a previously authorized digital media device 12 rejoins HHN 14 after a period of disconnection, commercial and consumer DMF 20 and 22 are automatically downloaded to the digital media device 12. This process of “synchronizing” digital media devices 12 to SSD 10 may be based upon a predetermined priority structure and copyright protection framework. In one embodiment, the synchronization process occurs automatically, without consumer intervention. In another embodiment utilizing a consumer-controlled synchronization process, a digital media device 12 automatically displays the content to be downloaded as part of the synchronization process, then waits for a consumer to select the particular DMF to be downloaded.

The synchronization priority may from device to device, depending to a certain extent on the capability of a digital media device 12 to play or record a particular DMF format. For example, in one embodiment, a digital camera 30 may only download digital photo files during the synchronization process, while a PMP 50 that is capable of playing video, displaying digital photos, and playing digital music files may download DMF of multiple formats. When a digital media device receives multiple formats during the synchronization process, a predetermined priority ranking of file formats determine the order in which new files get downloaded. For example, a PMP 50 that is capable of playing DMF of multiple formats may always download television first, home video second, music third, and digital photos last. Within each media format, other priorities may be set, such as downloading the oldest file first, and the newest last. In one embodiment, the priority ranking is predetermined and stored in an SSD 10; while in another embodiment, a consumer may enter a priority preference. Further details regarding the synchronizing process may be found in Attachments A, B, and C, of the previously identified provisional application which has been incorporated by reference.

By automatically distributing commercial DMF 20 according to a predetermined copyright framework as described herein, a consumer may maximize his ability to create and distribute authorized copies of commercial DMF 20 through an SSD 10 and HHN 14 of the present invention without the fear of violating copyright law.

It will be understood that the principal objective of these measures to secure against unauthorized copying of commercial DMF 20 is not to guarantee absolute security, but rather to make any attempted unauthorized access or copying of the digital media content files sufficiently difficult, expensive and tedious that the vast majority of consumers will find it easier and more convenient to resort to purchase of commercial digital media content or other types of authorized use of digital media content that is not consumer-generated digital media content. In addition to the security techniques guided by the previously described copyright framework, additional security for commercial DMF 20 may be enhanced by various known encryption techniques and other DRM techniques, all of which may be managed by an SSD 10.

Still referring to FIG. 4, in one embodiment, global server 52 stores a consumer credit card number for each SSD 10, and is authorized to charge a consumer for any unauthorized copying or use of commercial DMF 20 by SSD 10 or digital media devices 12 connected to HHN 14. By associating a credit card with an HHN 14, the household network becomes a credentialed HHN 14. A credentialed HHN 14 assures digital content providers that any copying or use of commercial DMF within credentialed HHN 14 will be constrained by the boundaries of the copyright framework embedded in HHN 14, else charges may be assessed for unauthorized copying or use.

For example, a digital movie file is purchased from a content server 54 and downloaded to an SSD 10 which forms the hub of HHN 14. The copyright framework of HHN 14, stored on SSD 10 or global server 52, authorizes a consumer to store one back-up copy on SSD 10 and distribute and store one additional copy on automobile DVR 32. If a consumer or third party attempts to circumvent the SSD 10 security and controls that implement the copyright framework by downloading a third copy from peer SSD 10a to a personal computer 38, SSD 10 will authorize global server 52 to implement a charge against a consumer's credit card.

Referring to FIG. 4a, in one embodiment, a user controls the assignment of a credit card to devices such as SSDs 10 and individual digital media devices 12 through a user interface such as NPG 40 user interface. In one embodiment, a digital media device 12 is enrolled through SSD 10 into HHN 14. As depicted in FIG. 4a, before enrollment can be completed in this embodiment, a user must approve assignment of the device to the credit card account. In other embodiments, a user controls voluntary charges to the credit card account through NPG 40. Further, charges to the credit card account for the household network may be displayed to the user to permit the user to periodically verify and/or audit transactions and/or authorized devices that are part of the household network to which the credit card account has been associated.

The amount that a consumer is charged for unauthorized copying may be set by a predetermined liquidation clause or some other fee structure built into a EULA and agreed upon by a consumer upon the purchase and use of an SSD 10. In another embodiment, the consumer may also utilize the credit card information to automatically deduct charges for accessing commercial digital media content. It will be understood that any number of variations on the fee and charge structure can be implemented in accordance with the present invention.

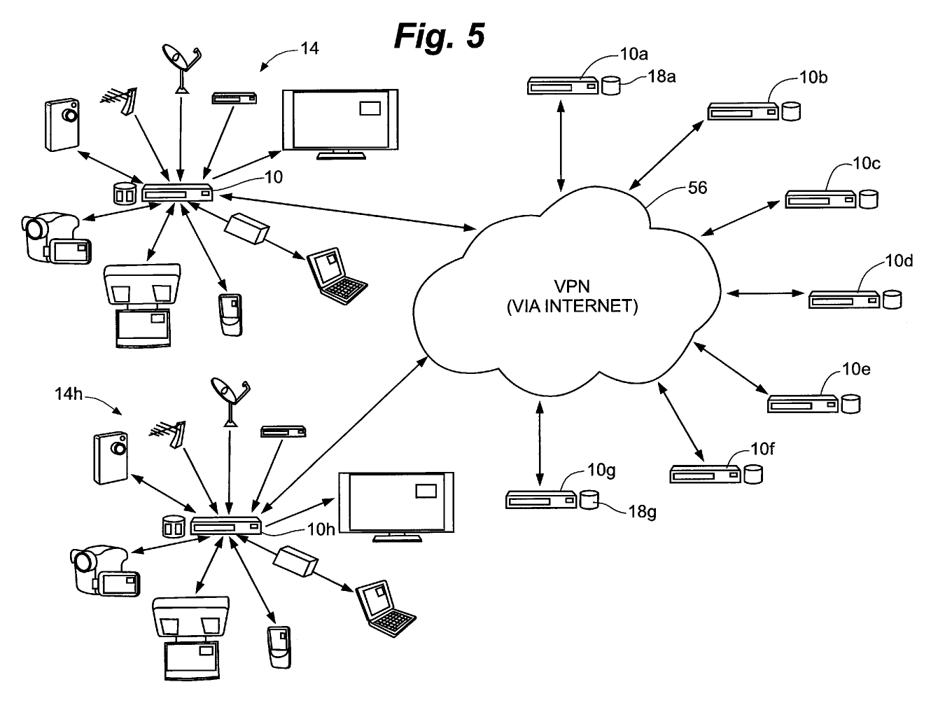

Referring now to FIG. 5, in one embodiment, an SSD 10 of HHN 14 is part of a larger family/friends virtual private network (FFVPN) 56, where consumer DMF 22 and authorized copies of commercial DMF 20 are exchanged between a multitude of SSDs 10, including SSDs 10a-10h using P2P file sharing techniques. In one embodiment, SSD 10 invites other SSDs 10a-10h to join VPN 56 and link to HHN 14. Other SSDs 10 may belong to family members or friends of SSD 10, and consumer DMF may be shared freely amongst those SSDs 10 that are members of FFVPN 56. In one embodiment, exchange of commercial DMF 20 is subject to the security measures and copyright framework described previously. In another embodiment, exchange of commercial DMF 20 is restricted to only the HHN 14 of one SSD, while consumer DMF 22 may be distributed among any of the HHNs 14 or other digital media devices that have been linked to the FFVPN 56

In one embodiment of the present invention, SSDs 10 in FFVPN 56 include a mass storage 18 that is partitioned into a consumer portion and a VPN portion. Any combination of commercial and consumer DMF 20 and 22 may be stored on each portion of mass storage 18, depending on the security measures and copyright framework desired.

Although virtually any P2P file-sharing techniques may be used to transfer files between SSDs connected to FFVPN 56, one embodiment of the present invention uses swarming techniques. Commercial DMF 20 and consumer DMF 22 are transferred among the SSDs 10 by a packet-based, P2P swarming protocol, such as the SwarmCast™ technique available from Onion Networks and described, for example, in U.S. patent applications Ser. Nos. 10/033,305 and 10/788,695, the disclosure of each of which is hereby incorporated by reference. Alternatively, other equivalent packet-based, peer-to-peer swarming protocols such as BitTorrent™ or BearShare™ may be utilized as the programming techniques for establishing the FFVPN 56 among the SSDs 10 in accordance with this embodiment the present invention. In one embodiment of SwarmCast as utilized by one embodiment of the present invention, a request over the FFVPN 56 for a given DMF 20 or 22 provides for preferential loading of, for example, beginning of movie, or segments of movie after the point at which the user is watching the movie.

Further details relating to SSDs 10 incorporated into a VPN, including partitioning mass storage 18 and P2P file-sharing techniques, may be found in U.S. patent application Ser. No. 11/649,351, “Digital Content Delivery Via Virtual Private Network (VPN) Incorporating Secured Set-Top Devices,” filed Jan. 3, 2007, the disclosure of which is hereby incorporated by reference.

Although the present invention has been described with respect to the various embodiments, it will be understood that numerous insubstantial changes in configuration, arrangement or appearance of the elements of the present invention can be made without departing from the intended scope of the present invention. Accordingly, it is intended that the scope of the present invention be determined by the claims as set forth.

What is claimed is:

1. A method for establishing a household network, comprising:
providing a secure set-top device (SSD) operably connected to the Internet;
assigning the SSD to a credit card account to define a household network associated with the SSD;
enrolling a digital media device in the household network;
requesting a digital media file for a digital media device within the household network, including:
verifying that the digital media file is valid for the household network; and
if valid, causing the SSD to process the request including identifying the digital media device and authorizing a charge to the credit card account, if required, to complete the request.

2. The method of claim 1, further comprising:
displaying to a user household network devices assigned to the credit card account, such that the user assumes responsibility for enrollment of the SSD or digital media device in the household network.

3. The method of claim 1, further comprising:
causing charges to the credit card account for the household network to be displayed to the user to permit the user to audit transactions.

4. The method of claim 1, wherein authorizing the charge to the credit card further includes verifying that the digital media device is located at an authorized IP address.

5. The method of claim 1, wherein the SSD is a device selected from the group consisting of a set-top box (STB), digital entertainment center (DEC), a personal video recorder (PVR), a secured portable device (SPD) and a secured auto device (SAD).

6. The method of claim 1, wherein the digital media device is a device selected from the group consisting of a digital video camera, digital camera, automobile digital video player or recorder, portable media device, monitor, television, personal computers, digital photo display frames, digital audio player.

7. The method of claim 1, wherein the digital media devices are all of the same brand.

8. A household network, comprising:
a plurality of digital media devices for receiving digital media files;
a secure set-top device (SSD) operably connected to the Internet and assigned to a credit card account;
wherein the SSD enrolls the digital media devices into the household network, authorizes the receipt of digital media files, and authorizes charges to the credit card account.

9. The household network of claim 1, wherein the SSD is a device selected from the group consisting of a set-top box (STB), digital entertainment center (DEC), a personal video recorder (PVR), a secured portable device (SPD) and a secured auto device (SAD).

10. The household network of claim 1, wherein the at least one of the plurality of digital media devices is a device selected from the group consisting of a digital video camera, digital camera, automobile digital video player or recorder, portable media device, monitor, television, personal computers, digital photo display frames, digital audio player.

11. The household network of claim 1, wherein the plurality of digital media devices are all of the same brand.
